(19) United States
(12) Patent Application Publication
(10) Pub. No.: US 2025/0209903 A1
(43) Pub. Date: Jun. 26, 2025

(54) DEVICE EVENT STATE ALARM FOR AN EVENT CONFLICT CONDITION

(71) Applicant: Motorola Mobility LLC, Chicago, IL (US)

(72) Inventors: Amit Kumar Agrawal, Bangalore (IN); Krishnan Raghavan, Bangalore (IN)

(73) Assignee: Motorola Mobility LLC, Chicago, IL (US)

(21) Appl. No.: 18/390,568

(22) Filed: Dec. 20, 2023

(51) Int. Cl. G08B 21/24

(52) U.S. Cl. CPC G08B 21/24

(57) ABSTRACT

Techniques for device event state alarm for an event conflict condition are described. For instance, the described techniques can be implemented to detect that a state condition of a client device may conflict with a scheduled event associated with the client device. An event state alarm can be output including actions that can be performed to mitigate an event conflict condition.

### BACKGROUND

Today's person is afforded a tremendous selection of devices that are capable of performing a multitude of tasks. Further, persons may share devices such as in household scenarios where family members may share a single device at different times for various purposes.

### BRIEF DESCRIPTION OF THE DRAWINGS

Aspects of device event state alarm for an event conflict condition are described with reference to the following Figures. The same numbers may be used throughout to reference similar features and components that are shown in the Figures. Further, identical numbers followed by different letters reference different instances of features and components described herein:

FIG. 1 illustrates an example environment in which aspects of device event state alarm for an event conflict condition can be implemented.

FIG. 2 illustrates examples scenarios for device event state alarm for an event conflict condition in accordance with aspects of the present disclosure.

FIG. 3 illustrates examples scenarios for device event state alarm for an event conflict condition in accordance with aspects of the present disclosure.

FIG. 4 depicts an example event state alarm in accordance with aspects of the present disclosure.

FIG. 5 depicts an example event state alarm in accordance with aspects of the present disclosure.

FIG. 6 depicts an example event state alarm in accordance with aspects of the present disclosure.

FIG. 7 depicts an example event state alarm in accordance with aspects of the present disclosure.

FIG. 8 illustrates a flow chart depicting an example method for device event state alarm for an event conflict condition in accordance with one or more implementations.

FIG. 9 illustrates a flow chart depicting an example method for device event state alarm for an event conflict condition in accordance with one or more implementations.

FIG. 10 illustrates a flow chart depicting an example method for device event state alarm for an event conflict condition in accordance with one or more implementations.

FIG. 11 illustrates various components of an example device in which aspects of device event state alarm for an event conflict condition can be implemented.

### DETAILED DESCRIPTION

Techniques for device event state alarm for an event conflict condition are described. For instance, the described techniques can be implemented to detect that a state of a client device may cause a conflict condition with an event associated with the client device. Further, various event state alarms can be output to attempt to mitigate the conflict condition.

For instance, consider an environment of a household in which parents and children reside. Occasionally a child may borrow a parent's device (e.g., a smartphone, a tablet device, a laptop, etc.) to perform various tasks such as schoolwork, play games, watch digital content, etc. While normally such behavior may be allowed and/or encouraged, in some scenarios this can cause disruption of an important scheduled event. For example, after a long day of work a parent may have an important evening call scheduled. To attempt to reenergize before the call the parent may take a nap and in conjunction set an alarm on their device to awaken prior to the call. However, after the parent sets the alarm and begins napping a child may take the parent's device to a different location to perform a task. Thus, the device may be in a location where the parent cannot detect the alarm when the alarm fires. Accordingly, the described implementations enable device notifications to be presented that notify the child that the parent has an upcoming important call and suggests that the device be returned to within proximity of the parent such that the parent can detect the upcoming alarm.

As another example the parent may have an upcoming call scheduled and may place their device on a charger to ensure that the device has sufficient battery charge to last for the call. A child, however, may remove the device from the charger to perform a task. Accordingly, the described implementations enable device notifications to be presented that notify the child that the parent has an upcoming important call and suggests that the device be placed on a charger to ensure that a battery charge of the device is sufficient for the upcoming call.

Thus, techniques described herein enable device performance to be improved such as by enabling increased probability of device presence and power availability for device-related events.

While features and concepts of device event state alarm for an event conflict condition can be implemented in any number of environments and/or configurations, aspects the described techniques are described in the context of the following example systems, devices, and methods. Further, the systems, devices, and methods described herein are interchangeable in various ways to provide for a wide variety of implementations and operational scenarios.

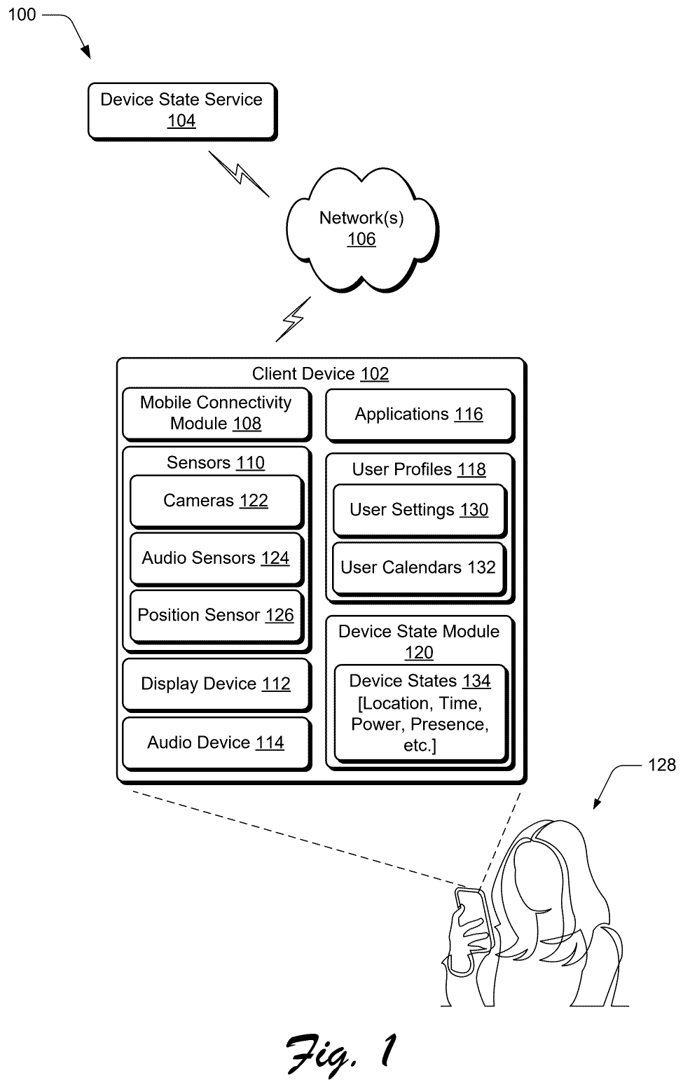

FIG. 1 illustrates an example environment 100 in which aspects of device event state alarm for an event conflict condition can be implemented. The environment 100 includes a client device 102 and a device state service 104 that are interconnectable via network(s) 106. The client device 102 can be implemented in various ways such as a mobile phone, a tablet device, a laptop, an extended reality (XR) device, and so forth. Example attributes and implementations of the client device 102 are discussed below with reference to the device 11 of FIG. 1100.

The client device 102 includes various functionality that enables the client device 102 to perform different aspects of device event state alarm for an event conflict condition discussed herein, including a mobile connectivity module 108, sensors 110, display device 112, audio device 114, applications 116, user profiles 118, and a device state module 120. The mobile connectivity module 108 represents functionality (e.g., logic and hardware) for enabling the client device 102 to interconnect with other devices and/or networks, such as the network 106. The mobile connectivity module 108, for instance, enables wireless and/or wired connectivity of the client device 102.

The sensors 110 are representative of functionality to detect various physical and/or logical phenomena in relation to the client device 102, such as motion, light, image detection and recognition, time and date, position, location, touch detection, sound, temperature, and so forth. Examples of the sensors 110 include hardware and/or logical sensors such as an accelerometer, a gyroscope, a camera, a microphone, a clock, biometric sensors, touch input sensors, position sensors, environmental sensors (e.g., for temperature, pressure, humidity, and so on), geographical location information sensors (e.g., Global Positioning System (GPS) functionality), and so forth. In this particular example the sensors 110 include cameras 122, audio sensors 124, and a position sensor 126. The sensors 110, however, can include a variety of other sensor types in accordance with the implementations discussed herein.

The display device 112 represents functionality for outputting visual content via the client device 102 and the audio device 114 represents functionality for outputting audio content for the client device 102. The applications 116 represent functionality for performing different computing tasks via the client device 102, such as gaming, media consumption (e.g., content streaming), productivity tasks (e.g., email, calendar management, word processing, content generation, data analysis, etc.), content generation, web browsing, communication with other devices, and so forth.

The user profiles 118 represent functionality for tracking various user attributes for users associated with the client device 102, such as a user 128. For instance, the user profiles 118 include user settings 130 which represent various user-specific behaviors to be applied for instances of the user profiles 118, such as biometric settings (e.g., for identifying user biometric attributes), notification settings, access permissions, authentication settings (e.g., passwords, biometric attributes, etc.), and so forth. The user profiles 118 also include user calendars 132 which represent schedules for user events associated with respective instances of the user profiles 118, such as user-schedules meetings, alarms, reminders, and/or other types of events. In at least some implementations the user calendars 132 can include events scheduled and/or managed via the applications 116.

The device state module 120 represents functionality for performing various aspects of device event state alarm for an event conflict condition described herein. For instance, the device state module 120 can utilize sensor data from the sensors 110 to determine and monitor different device states 134 of the client device 102. Examples of the device states 134 of the client device 102 include device position, persons in proximity to the client device 102, date, time of day, power states, etc. Further, the device state module 120 can access the user profiles 118 to determine various user-specific information, such as the user settings 130 and/or the user calendars 132 for different instances of the user profiles 118. As further detailed herein the device state module 120 can detect different state triggers for the client device 102 and trigger various state alarms when a state trigger pertaining to the client device 102 occurs.

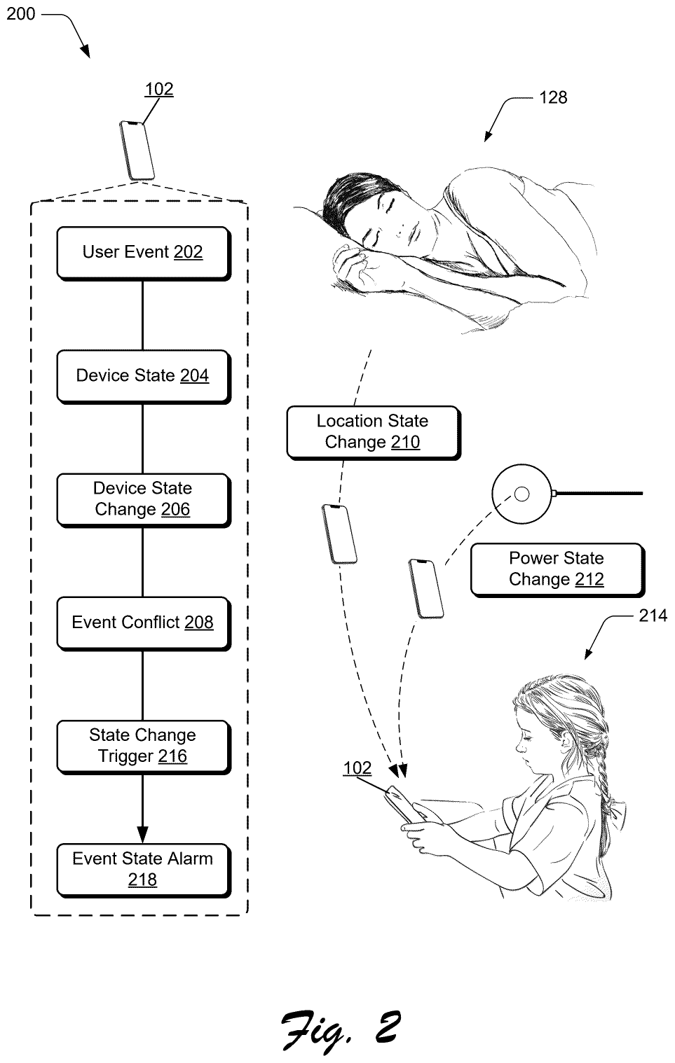

FIG. 2 illustrates examples scenarios 200 for device event state alarm for an event conflict condition in accordance with aspects of the present disclosure. In the scenarios 200 a user event 202 is stored for the client device 102. The user event 202 can be generated in different ways, such as part of a user calendar 132, via an application 116, via a system setting of the client device 102, etc. Examples of the user event 202 include a calendar event, an alarm (e.g., a clock-based alarm), a state change event (e.g., a location change event, a user presence event, etc.), and so forth.

Further, the device state module 120 monitors device state 204 of the client device 102 such as device location, power state (e.g., battery charge level, battery charger connectivity, etc.), user presence (e.g., identity of a person in possession of the client device 102), etc. The device state module 120, for instance, receives sensor data from the sensors 110 to determine different state conditions of the client device 102, such as device location, identities of users in proximity to the client device 102, time of day, date, power state (e.g., battery charge level, charger connectivity, etc.), and so forth.

As part of monitoring the device state 204 the device state module 120 detects a device state change 206 and determines that an event conflict 208 may occur based on the user event 202 and the device state change 206. Examples of the device state change 206 include a location state change 210 of the client device 102 and/or a power state change 212 of the client device.

For instance, in the context of the location state change 210 consider a scenario where the user event 202 represents an alarm that the user 128 has set on the client device 102 to wake the user 128 from a nap for an important call. After setting the alarm the user 128 places the client device 102 in sufficient proximity to enable the user 128 to detect expiry of the alarm. Another user 214, however, obtains possession of the client device 102 to perform a task (e.g., make a call, play a game, etc.) and takes the client device 102 to a different location that may not be in sufficient proximity to enable the user 128 to detect expiry of the alarm. The device state module 120 determines that an identity of the user 214 is different than an identity of the user 128, such as based on biometric detection of attributes of the user 214 and comparison to biometric attributes of the user 128.

Accordingly, the device state module 120 detects the event conflict 208 as an indication that at a current location of the client device 102, the user 128 may be unable to detect expiry of the alarm. The device state module 120 fires a state change trigger 216 which causes an event state alarm 218 to be output. The event state alarm 218, for instance, includes visual, audible, and/or tactile output via the client device 102 configured to inform the user 214 of the upcoming alarm set by the user 128. Examples of the event state alarm 218 are discussed below.

As another example and in the context of the power state change 212, consider that the user event 202 represents an upcoming call scheduled by the user 128 and the user 214 disconnects the client device 102 from a charger. Further, a battery charge level of the client device 102 may be below a threshold charge level, e.g., below 50%. In at least one example and as part of the event conflict 208 the device state module 120 detects based on biometric attributes of the user 214 that an identity of the user 214 is different than an identity of the user 128. Accordingly, the event conflict 208 can represent an indication that a power state of the client device 102 may be insufficient for the upcoming call which can cause the state change trigger 216 to be fired. Further, the event state alarm 218 can be configured to provide a suggested action based on the power state change 212. Examples of the event state alarm 218 are discussed below.

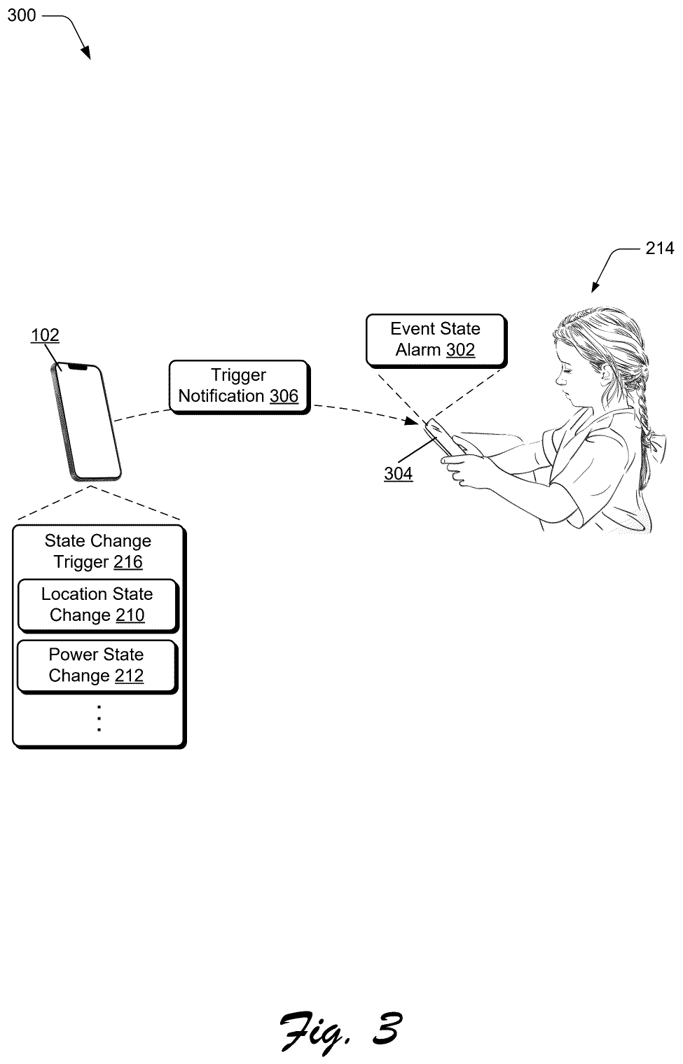

FIG. 3 illustrates example scenarios 300 for device event state alarm for an event conflict condition in accordance with aspects of the present disclosure. The scenarios 300, for example, represent alternative or additional implementations to the scenarios 200. In the scenarios 300 the state change trigger 216 pertaining to the client device 102 occurs, such as described above. The state change trigger 216, for instance, is based on the location state change 210, the power state change 212, and/or other state change. In the scenarios 300, an event state alarm 302 is triggered and output via a different client device 304 other than the client device 102.

For instance, consider a scenario where the user 214 moves the client device 102 to a different location such as described above with reference to the location state change 210. Alternatively or additionally the user 214 removes the client device 102 from a battery charger. The user 214 then leaves the client device 102 at the different location and begins interacting with the different client device 304, such as a client device registered with the user 214. The state change trigger 216 can occur on the client device 102 and a trigger notification 306 can be transmitted to the client device 304, which causes the event state alarm 302 to be output via the client device 304. The trigger notification 306 can be transmitted via direct device-to-device connectivity between the client device 102 and the client device 304, and/or via a network intermediary such as the device state service 104. The event state alarm 302 can suggest that the client device 102 be moved to within a threshold proximity to the user 128 and/or that the client device 102 be reconnected to a battery charger.

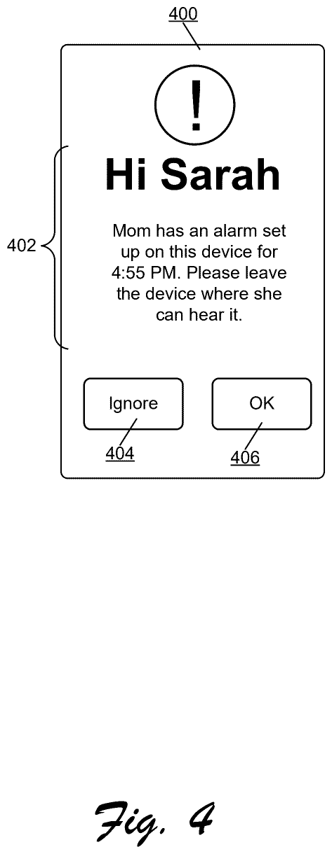

FIG. 4 depicts an example event state alarm 400 in accordance with aspects of the present disclosure. The event state alarm 400, for example, represents an implementation of the event state alarm 218. The event state alarm 400 includes a notification region 402 that includes information describing an event conflict and providing a suggestion for responding to the event conflict. For instance, in the context of the location state change 210, the notification region 402 is populated with a text description of a suggested action, e.g., to return the client device 102 to within a proximity of the user 128 such that an alarm output by the client device 102 is detectable by the user 128. Additionally or alternatively to a graphics-based output, the event state alarm 400 can utilize other output types such as audio output, tactile output, etc.

The event state alarm 400 also includes an ignore control 404 and an acknowledge control 406. The ignore control 404 is selectable to cause the event state alarm 400 to be dismissed. The acknowledge control 406 is selectable to indicate that an action suggested by the event state alarm 400 will be performed. In at least one implementation, in response to selection of the acknowledge control 406 a navigation experience can be presented that provides navigation directions for placing the client device 102 in a suggested proximity to the user 128, e.g., a most recently detected position of the user 128.

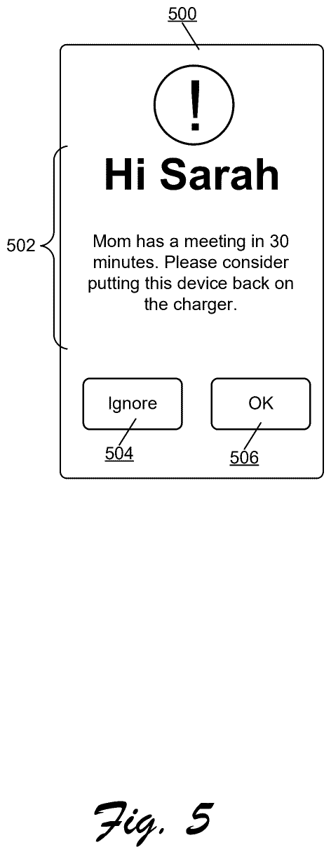

FIG. 5 depicts an example event state alarm 500 in accordance with aspects of the present disclosure. The event state alarm 500, for example, represents an implementation of the event state alarm 218. The event state alarm 500 includes a notification region 502 that includes information describing an event conflict and providing a suggestion for responding to the event conflict. For instance, in the context of the power state change 212, the notification region 502 is populated with a text description of a suggested action, e.g., to place the client device 102 on a charging device. Additionally or alternatively to a graphics-based output, the event state alarm 500 can utilize other output types such as audio output, tactile output, etc.

The event state alarm 500 also includes an ignore control 504 and an acknowledge control 506. The ignore control 504 is selectable to cause the event state alarm 500 to be dismissed. The acknowledge control 506 is selectable to indicate that an action suggested by the event state alarm 500 will be performed. In at least one implementation, in response to selection of the acknowledge control 506 a navigation experience can be presented that provides navigation directions for placing the client device 102 on a charging device.

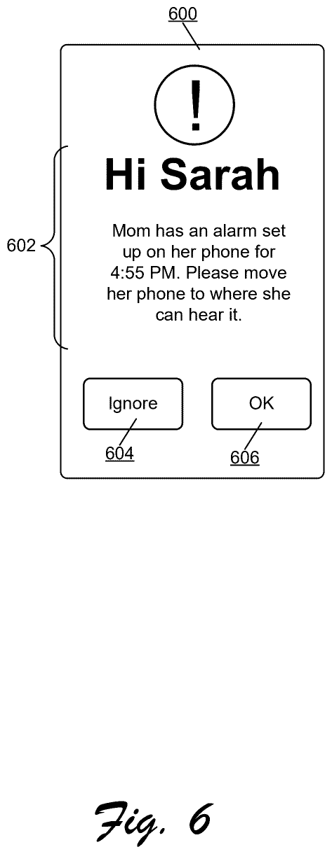

FIG. 6 depicts an example event state alarm 600 in accordance with aspects of the present disclosure. The event state alarm 600, for example, represents an implementation of the event state alarm 302. For instance, the event state alarm 600 is presented on a secondary device (e.g., the client device 304) based on a state change trigger 216 that occurs on a primary device, e.g., the client device 102.

The event state alarm 600 includes a notification region 602 that includes information describing an event conflict and providing a suggestion for responding to the event conflict. For instance, in the context of the location state change 210, the notification region 602 is populated with a text description of a suggested action, e.g., to place the client device 102 in proximity to the user 128. Additionally or alternatively to a graphics-based output, the event state alarm 600 can utilize other output types such as audio output, tactile output, etc.

The event state alarm 600 also includes an ignore control 604 and an acknowledge control 606. The ignore control 604 is selectable to cause the event state alarm 600 to be dismissed. The acknowledge control 606 is selectable to indicate that an action suggested by the event state alarm 600 will be performed. In at least one implementation, in response to selection of the acknowledge control 606 a navigation experience can be presented that indicates a current location of the client device 102 and that provides navigation directions for placing the client device 102 in a suggested proximity to the user 128, e.g., a most recently detected position of the user 128.

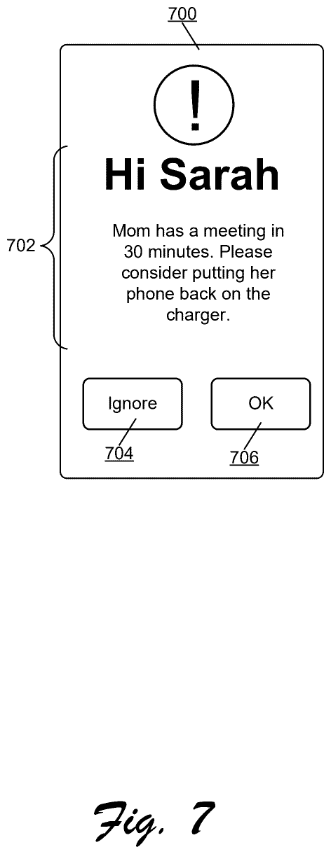

FIG. 7 depicts an example event state alarm 700 in accordance with aspects of the present disclosure. The event state alarm 700, for example, represents an implementation of the event state alarm 302. For instance, the event state alarm 700 is presented on a secondary device (e.g., the client device 304) based on a state change trigger 216 that occurs on a primary device, e.g., the client device 102.

The event state alarm 700 includes a notification region 702 that includes information describing an event conflict and providing a suggestion for responding to the event conflict. For instance, in the context of the power state change 212, the notification region 702 is populated with a text description of a suggested action, e.g., to place the client device 102 on a charging device. Additionally or alternatively to a graphics-based output, the event state alarm 700 can utilize other output types such as audio output, tactile output, etc.

The event state alarm 700 also includes an ignore control 704 and an acknowledge control 706. The ignore control 704 is selectable to cause the event state alarm 700 to be dismissed. The acknowledge control 706 is selectable to indicate that an action suggested by the event state alarm 700 will be performed. In at least one implementation, in response to selection of the acknowledge control 706 a navigation experience can be presented that indicates a current location of the client device 102 and that provides navigation directions for placing the client device 102 on a charging device.

In implementations an escalated alarm notification scheme can be implemented such as when a condition that results in an event conflict 208 and/or a state change trigger 216 is not remedied. For instance, where an event conflict 208 remains unresolved within a particular time threshold before a user event 202, the event state alarms described above can be augmented with additional alarm types, such as more urgent visual reminders, additional audible reminders, tactile reminders, and/or combinations thereof.

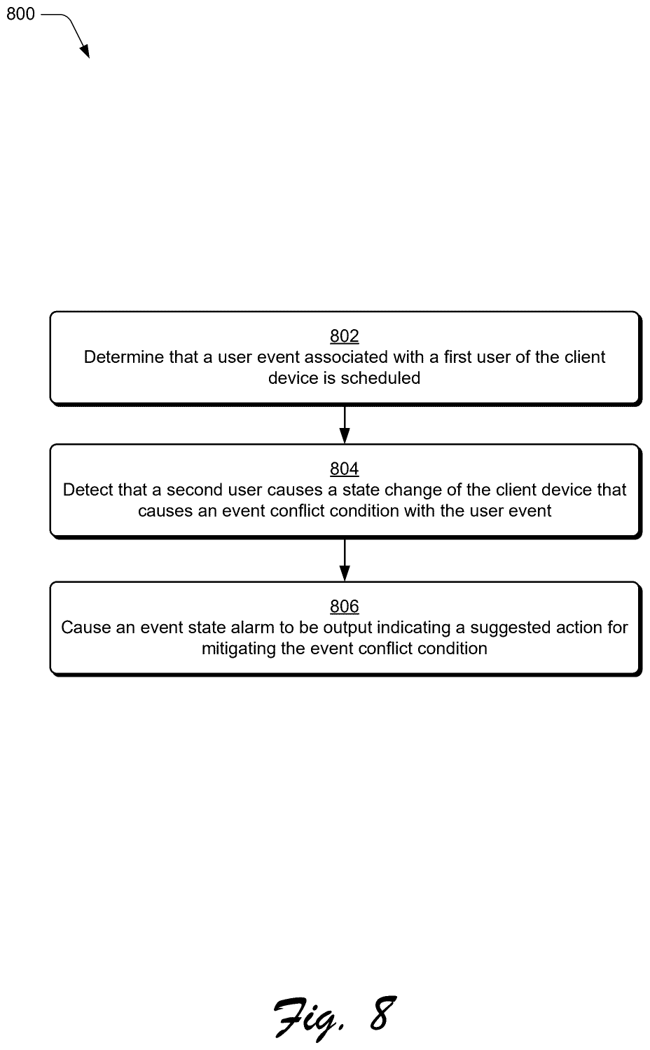

FIG. 8 illustrates a flow chart depicting an example method 800 for device event state alarm for an event conflict condition in accordance with one or more implementations. At 802 it is determined that a user event associated with a first user of the client device is scheduled. The device state module 120, for instance, determines that a user event associated with the user 128 of the client device 102 is scheduled.

At 804 it is detected that a second user causes a state change of the client device that causes an event conflict condition with the user event. For instance, the device state module 120 detects that the user 214 interacts with the client device 102 to perform an action such as moving the client device 102 outside of a threshold proximity to the user 128, disconnecting the client device 102 from a battery charging device, etc. The device state module 120, for example, can utilize sensor data from the sensors 110 to detect various state information pertaining to the client device 102, such as an identity of a user interacting with and/or in possession of the client device 102 (e.g., whether the user is the user 128, the user 214, or a different user), a location of the client device 102, a power state of the client device 102 (e.g., a battery charge level, whether a battery of the client device 102 is in a charging state, etc.), and so forth.

Further, the device state module 120 can determine that the second user in possession of the client device 102 is different than the first associated with the user event such that the first user may be adversely affected by the event conflict condition.

The device state module 120 can also detect a time differential between a current time and a scheduled time for the user event. In implementations multiple time thresholds can be utilized such as to determine whether an event conflict may occur with the user event. For instance, when the state change applies within a time threshold t of the scheduled time of the user event, the device state module 120 determines that an event conflict condition occurs.

At 806 an event state alarm is caused to be output indicating a suggested action for mitigating the event conflict condition. For example, the device state module 120 causes an event state alarm to be output including a suggested action to be performed by the second user. The event state alarm can be output at the client device and/or at a different client device, such as a different client device associated with the second user. Examples of different event state alarms are discussed above and illustrated in the accompanying figures.

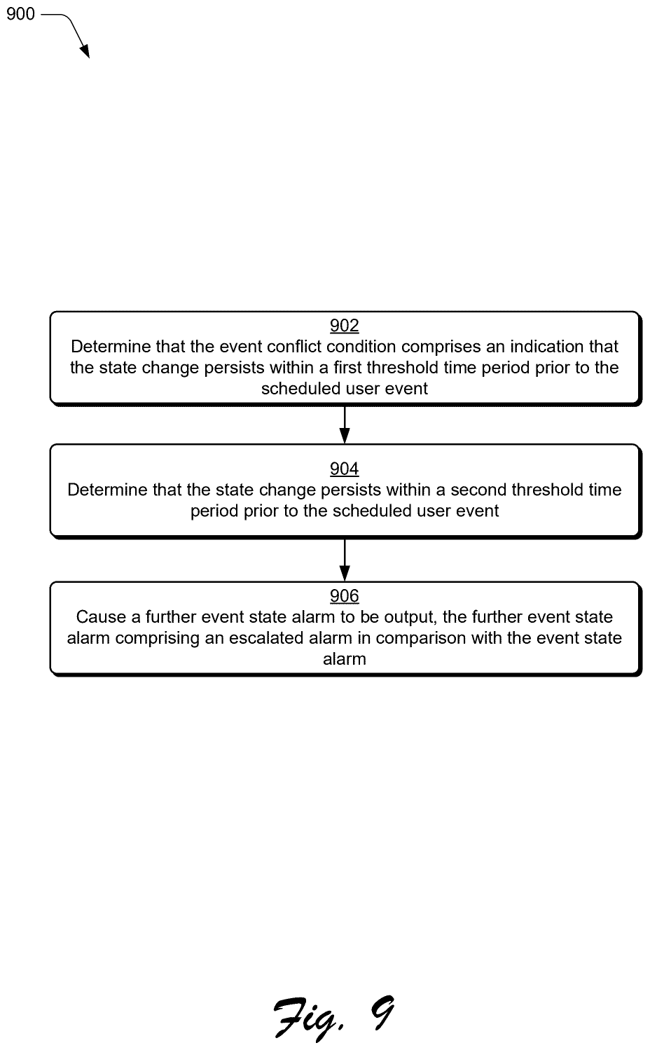

FIG. 9 illustrates a flow chart depicting an example method 900 for device event state alarm for an event conflict condition in accordance with one or more implementations. At 902 it is determined that the event conflict condition comprises an indication that the state change persists within a first threshold time period prior to the scheduled user event. As mentioned above, for instance, the device state module 120 can monitor multiple time thresholds prior to a user event. The occurrence and/or existence of a device state change within a time threshold t from the user event, for instance, can be utilized to detect that an event conflict condition occurs.

At 904 it is determined that the state change persists within a second threshold time period prior to the scheduled user event. The second threshold time, for instance, represents a smaller time threshold, e.g., t-n. For example, the device state module 120 detects that the event conflict condition has not been mitigated, e.g., that the client device 102 remains outside of a threshold proximity to the user 128, that the client device 102 remains disconnected from a battery charging device, etc.

At 906 a further event state alarm is caused to be output, the further event state alarm comprising an escalated alarm in comparison with the event state alarm. The further event state alarm, for example, can include additional alarm types in comparison with the initial event state alarm, such as adding an audio alarm, a tactile alarm, etc. Alternatively or additionally the further event state alarm can add emphasis to the initial event state alarm, such as via increased visual output, increased audio volume, increase tactile output intensity, etc.

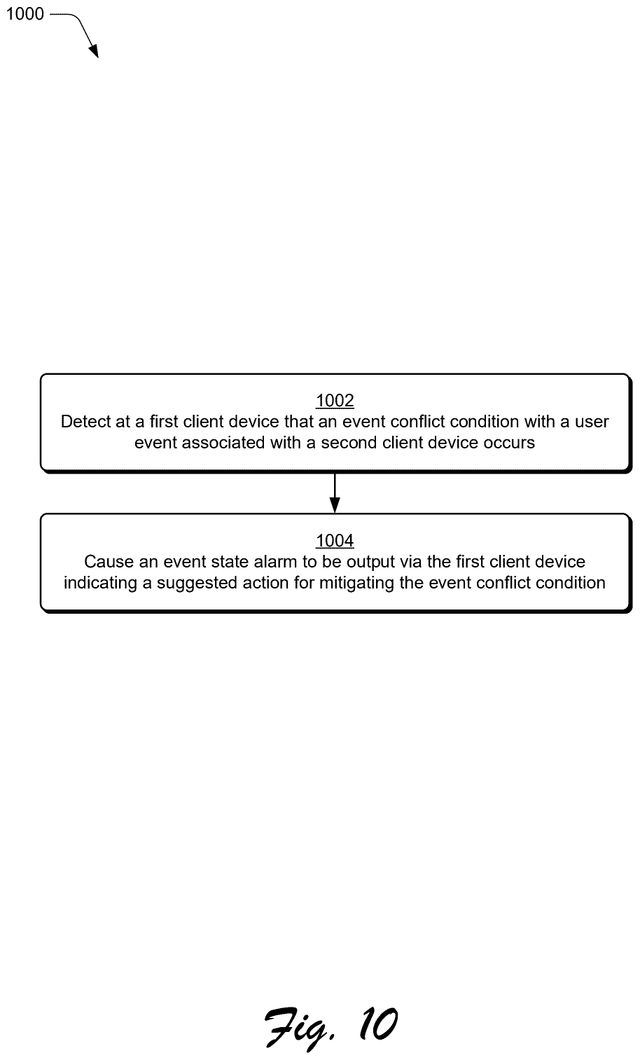

FIG. 10 illustrates a flow chart depicting an example method 1000 for device event state alarm for an event conflict condition in accordance with one or more implementations. At 1002 it is detected, at a first client device, that an event conflict condition with a user event associated with a second client device occurs. For instance, the client device 304 receives a notification that an event conflict condition associated with the client device 102 occurs.

At 1004 an event state alarm is caused to be output via the first client device indicating a suggested action for mitigating the event conflict condition. The client device 304, for instance, identifies the client device 102, indicates that an event conflict condition with the client device 102 is detected, and identifies a suggested action for mitigating the event conflict condition. Examples of different event state alarms are described above and illustrated in the accompanying figures.

The example methods described above may be performed in various ways, such as for implementing different aspects of the systems and scenarios described herein. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

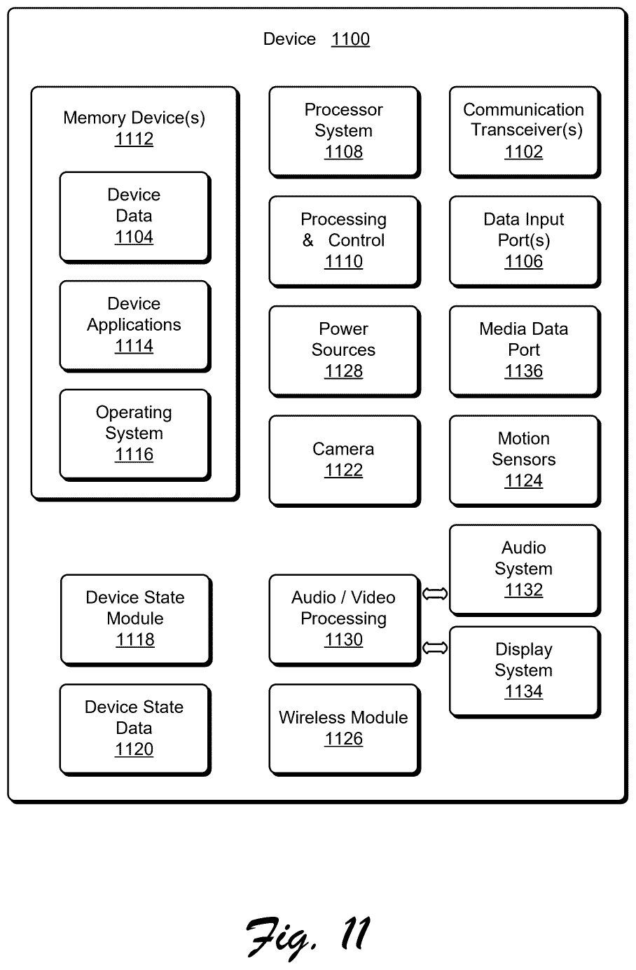

FIG. 11 illustrates various components of an example device 1100 in which aspects of device event state alarm for an event conflict condition can be implemented. The example device 1100 can be implemented as any of the devices described with reference to the previous FIGS. 1-10, such as any type of client device, mobile phone, mobile device, wearable device, tablet, computing, communication, entertainment, gaming, media playback, and/or other type of electronic device. For example, the client device 102 and/or the client device 304 as shown and described with reference to FIGS. 1-10 may be implemented as the example device 1100.

The device 1100 includes communication transceivers 1102 that enable wired and/or wireless communication of device data 1104 with other devices. The device data 1104 can include any of device identifying data, device location data, wireless connectivity data, and wireless protocol data. Additionally, the device data 1104 can include any type of audio, video, and/or image data. Example communication transceivers 1102 include wireless personal area network (WPAN) radios compliant with various IEEE 802.15 (Bluetooth™) standards, wireless local area network (WLAN) radios compliant with any of the various IEEE 802.11 (Wi-Fi™) standards, wireless wide area network (WWAN) radios for cellular phone communication, wireless metropolitan area network (WMAN) radios compliant with various IEEE 802.16 (WiMAX™) standards, and wired local area network (LAN) Ethernet transceivers for network data communication.

The device 1100 may also include one or more data input ports 1106 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 1100 includes a processing system 1108 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 1110. The device 1100 may further include any type of a system bus or other data and command transfer system that couples the various components within the device. A system bus can include any one or combination of different bus structures and architectures, as well as control and data lines.

The device 1100 also includes computer-readable storage memory 1112 (e.g., memory devices) that enable data storage, such as data storage devices that can be accessed by a computing device, and that provide persistent storage of data and executable instructions (e.g., software applications, programs, functions, and the like). Examples of the computer-readable storage memory 1112 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 1100 may also include a mass storage media device.

The computer-readable storage memory 1112 provides data storage mechanisms to store the device data 1104, other types of information and/or data, and various device applications 1114 (e.g., software applications). For example, an operating system 1116 can be maintained as software instructions with a memory device and executed by the processing system 1108. The device applications may also include a device manager, such as any form of a control application, software application, signal-processing and control module, code that is native to a particular device, a hardware abstraction layer for a particular device, and so on. Computer-readable storage memory 1112 represents media and/or devices that enable persistent and/or non-transitory storage of information in contrast to mere signal transmission, carrier waves, or signals per se. Computer-readable storage memory 1112 do not include signals per se or transitory signals.

In this example, the device 1100 includes a device state module 1118 that can implement aspects of device event state alarm for an event conflict condition and may be implemented with hardware components and/or in software as one of the device applications 1114. For example, the device state module 1118 can be implemented as the device state module 120. In implementations, the device state module 1118 may include independent processing, memory, and logic components as a computing and/or electronic device integrated with the device 1100. The device 1100 also includes device state data 1120 for implementing aspects of device event state alarm for an event conflict condition and may include data from the device state module 1118.

In this example, the example device 1100 also includes a camera 1122 and motion sensors 1124, such as may be implemented in an inertial measurement unit (IMU). The motion sensors 1124 can be implemented with various sensors, such as a gyroscope, an accelerometer, and/or other types of motion sensors to sense motion of the device. The various motion sensors 1124 may also be implemented as components of an inertial measurement unit in the device.

The device 1100 also includes a wireless module 1126, which is representative of functionality to perform various wireless communication tasks. For instance, for the client device 102, the wireless module 1126 can be leveraged to scan for and detect wireless networks, as well as negotiate wireless connectivity to wireless networks for the client device 102. The device 1100 can also include one or more power sources 1128, such as when the device is implemented as a mobile device. The power sources 1128 may include a charging and/or power system, and can be implemented as a flexible strip battery, a rechargeable battery, a charged super-capacitor, and/or any other type of active or passive power source.

The device 1100 also includes an audio and/or video processing system 1130 that generates audio data for an audio system 1132 and/or generates display data for a display system 1134. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 1136. In implementations, the audio system and/or the display system are integrated components of the example device. Alternatively, the audio system and/or the display system are external, peripheral components to the example device.

Although implementations of device event state alarm for an event conflict condition have been described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

In some aspects, the techniques described herein relate to a client device including: one or more modules implementable at least in part in hardware of the client device to: determine that a user event associated with a first user of the client device is scheduled; detect that a second user causes a state change of the client device that causes an event conflict condition with the user event; and cause an event state alarm to be output indicating a suggested action for mitigating the event conflict condition.

In some aspects, the techniques described herein relate to a client device, wherein to detect that the second user causes the state change, the one or more modules are implementable to detect that an identity of the second user is different than an identity of the first user.

In some aspects, the techniques described herein relate to a client device, wherein the state change includes an indication that the client device is more than a threshold distance from the first user.

In some aspects, the techniques described herein relate to a client device, wherein the state change includes an indication that the client device is not connected to a charging device.

In some aspects, the techniques described herein relate to a client device, wherein the event conflict condition includes an indication that the state change persists within a first threshold time period prior to the scheduled user event.

In some aspects, the techniques described herein relate to a client device, wherein the state change includes an indication that the client device is more than a threshold proximity from the first user, and wherein the event state alarm includes an indication to move the client device to within the threshold proximity to the first user.

In some aspects, the techniques described herein relate to a client device, wherein the one or more modules are implementable to present a navigation experience for moving the client device to within the threshold proximity to the first user.

In some aspects, the techniques described herein relate to a client device, wherein the state change includes an indication that the client device is not connected to a charging device, and wherein the event state alarm includes an indication to connect the client device to the charging device.

In some aspects, the techniques described herein relate to a client device, wherein the one or more modules are implementable to present a navigation experience for connecting the client device to the charging device.

In some aspects, the techniques described herein relate to a client device, wherein to cause the event state alarm to be output, the one or more modules are implementable to transmit an indication of the event state alarm for output via a different client device associated with the second user.

In some aspects, the techniques described herein relate to a client device, wherein the event conflict condition includes an indication that the state change persists within a first threshold time period prior to the scheduled user event, and wherein the one or more modules are implementable to: determine that the state change persists within a second threshold time period prior to the scheduled user event; and cause a further event state alarm to be output, the further event state alarm including an escalated alarm in comparison with the event state alarm.

In some aspects, the techniques described herein relate to a first client device including: one or more modules implemented at least in part in hardware of the first client device to: detect that an event conflict condition with a user event associated with a second client device occurs; and cause an event state alarm to be output via the first client device indicating a suggested action for mitigating the event conflict condition.

In some aspects, the techniques described herein relate to a first client device, wherein the first client device is associated with a first user, and the user event is associated with a second user of the second client device.

In some aspects, the techniques described herein relate to a first client device, wherein the event conflict condition includes an indication that the second client device is more than a threshold distance from the second user, and wherein the event state alarm includes an indication to move the second client device to within the threshold distance to the second user.

In some aspects, the techniques described herein relate to a first client device, wherein the event conflict condition includes an indication that the second client device is not connected to a charging device, and wherein the event state alarm includes an indication to connect the second client device to the charging device.

In some aspects, the techniques described herein relate to a method, including: determining that a user event associated with a first user of a client device is scheduled; detecting that a second user causes a state change of the client device that causes an event conflict condition with the user event; and causing an event state alarm to be output indicating a suggested action for mitigating the event conflict condition.

In some aspects, the techniques described herein relate to a method, wherein the state change includes one or more of an indication that the client device is more than a threshold distance from the first user, or an indication that the client device is not connected to a charging device.

In some aspects, the techniques described herein relate to a method, wherein the state change includes an indication that the client device is more than a threshold distance from the first user, and wherein the event state alarm includes an indication to move the client device to within the threshold distance to the first user.

In some aspects, the techniques described herein relate to a method, wherein the state change includes an indication that the client device is not connected to a charging device, and wherein the event state alarm includes an indication to connect the client device to the charging device.

In some aspects, the techniques described herein relate to a method, wherein causing an event state alarm to be output includes transmitting an indication of the event state alarm for output via a different client device associated with the second user.

1. A client device comprising:
one or more modules implementable at least in part in hardware of the client device to:
determine that a user event associated with a first user of the client device is scheduled;
detect that a second user causes a state change of the client device that causes an event conflict condition with the user event; and
cause an event state alarm to be output indicating a suggested action for mitigating the event conflict condition.

2. The client device of claim 1, wherein to detect that the second user causes the state change, the one or more modules are implementable to detect that an identity of the second user is different than an identity of the first user.

3. The client device of claim 1, wherein the state change comprises an indication that the client device is more than a threshold distance from the first user.

4. The client device of claim 1, wherein the state change comprises an indication that the client device is not connected to a charging device.

5. The client device of claim 1, wherein the event conflict condition comprises an indication that the state change persists within a first threshold time period prior to the scheduled user event.

6. The client device of claim 1, wherein the state change comprises an indication that the client device is more than a threshold proximity from the first user, and wherein the event state alarm comprises an indication to move the client device to within the threshold proximity to the first user.

7. The client device of claim 6, wherein the one or more modules are implementable to present a navigation experience for moving the client device to within the threshold proximity to the first user.

8. The client device of claim 1, wherein the state change comprises an indication that the client device is not connected to a charging device, and wherein the event state alarm comprises an indication to connect the client device to the charging device.

9. The client device of claim 8, wherein the one or more modules are implementable to present a navigation experience for connecting the client device to the charging device.

10. The client device of claim 1, wherein to cause the event state alarm to be output, the one or more modules are implementable to transmit an indication of the event state alarm for output via a different client device associated with the second user.

11. The client device of claim 1, wherein the event conflict condition comprises an indication that the state change persists within a first threshold time period prior to the scheduled user event, and wherein the one or more modules are implementable to:
determine that the state change persists within a second threshold time period prior to the scheduled user event; and
cause a further event state alarm to be output, the further event state alarm comprising an escalated alarm in comparison with the event state alarm.

12. A first client device comprising:
one or more modules implemented at least in part in hardware of the first client device to:
detect that an event conflict condition with a user event associated with a second client device occurs; and
cause an event state alarm to be output via the first client device indicating a suggested action for mitigating the event conflict condition.

13. The first client device of claim 12, wherein the first client device is associated with a first user, and the user event is associated with a second user of the second client device.

14. The first client device of claim 13, wherein the event conflict condition comprises an indication that the second client device is more than a threshold distance from the second user, and wherein the event state alarm comprises an indication to move the second client device to within the threshold distance to the second user.

15. The first client device of claim 12, wherein the event conflict condition comprises an indication that the second client device is not connected to a charging device, and wherein the event state alarm comprises an indication to connect the second client device to the charging device.

16. A method, comprising:
determining that a user event associated with a first user of a client device is scheduled;
detecting that a second user causes a state change of the client device that causes an event conflict condition with the user event; and
causing an event state alarm to be output indicating a suggested action for mitigating the event conflict condition.

17. The method of claim 16, wherein the state change comprises one or more of an indication that the client device is more than a threshold distance from the first user, or an indication that the client device is not connected to a charging device.

18. The method of claim 16, wherein the state change comprises an indication that the client device is more than a threshold distance from the first user, and wherein the event state alarm comprises an indication to move the client device to within the threshold distance to the first user.

19. The method of claim 16, wherein the state change comprises an indication that the client device is not connected to a charging device, and wherein the event state alarm comprises an indication to connect the client device to the charging device.

20. The method of claim 16, wherein causing an event state alarm to be output comprises transmitting an indication of the event state alarm for output via a different client device associated with the second user.
